(19) United States
(12) Patent Application Publication
(10) Pub. No.: US 2023/0081561 A1
(43) Pub. Date: Mar. 16, 2023

(54) MAGNETIC FALSE EYELASHES AND PREPARATION METHOD THEREOF

(71) Applicant: QINGDAO HOMAY EYELASHES CO., LTD., Qingdao (CN)

(72) Inventor: MINGTAO ZHANG, Pingdu (CN)

(21) Appl. No.: 17/502,055

(22) Filed: Oct. 15, 2021

(30) Foreign Application Priority Data
Sep. 13, 2021 (CN) 202111067893.8

(51) Int. Cl. A41G 5/02

(52) U.S. Cl. CPC A41G 5/02

(57) ABSTRACT

Magnetic false eyelashes include an eyelash stem, multiple eyelash filaments evenly distributed on a first side of the eyelash stem, a magnetic glue layer arranged on the first side, and a soft magnetic strip or multiple magnetic blocks arranged between the magnetic glue layer and eyelash stem. The magnetic block is square or cylindrical, and the eyelashes are made of a biodegradable material or PBT. A preparation method of the same, including: (1) Preparing magnetic blocks; (2) Evenly gluing the eyelash filaments to a first side of an eyelash stem; (3) Inlaying a soft magnetic strip or 6˜20 magnetic blocks in the first side; (4) Preparing a magnetic glue; (5) Applying the magnetic glue to the exterior of the first side, and making it evenly distributed on the magnets and the eyelash stem, and letting it dry for at least half an hour.

### CROSS-REFERENCE TO RELATED APPLICATIONS

This is a U.S. patent application which claims the priority and benefit of Chinese patent application number 202111067893.8, filed on Sep. 13, 2021, the disclosure of which is incorporated herein by reference in its entirety.

### TECHNICAL FIELD

This disclosure relates to the field of cosmetics manufacturing, and more particularly relates to magnetic false eyelashes and a preparation method thereof.

### BACKGROUND

Magnetic false eyelashes have been popular in the market for several years as a fashionable fast-moving consumer product. Although they have been sought after by many beauty lovers, their shortcomings are also obvious, as follows.

1. In existing magnetic false eyelashes, 3-10 magnets are typically inlaid at the position of the eyelash stem with chemical quick-drying glue, where the sizes of the magnets have an even distribution depending on the length of the eyelash stem. Most of the magnets are 3 mm long×1 mm wide×0.3 mm high. They are relatively very large and prominent, where each magnet has edges and corners, and has a very obvious bumpy touch when inlaid in the eyelash stem. The corners and edges can easily scratch the eye skin. It is very uncomfortable to wear, and the magnet is very easy to fall off. It has a very small number of available use times, which also increases the cost of use.

2. The eyelashes are mostly made of PVC material, which is not environmentally friendly. A few eyelash filaments are made of PBT and PET materials, but they have defects such as long natural degradation time.

### SUMMARY

Purpose of the disclosure: The present disclosure addresses the above-mentioned problems in the related art, that is, the present disclosure discloses magnetic false eyelashes and a preparation method thereof.

Technical Solution: Magnetic false eyelashes including an eyelash stem, where a plurality of eyelash filaments are evenly distributed on a first side of the eyelash stem, a magnetic glue layer is arranged on the first side of the eyelash stem, and a soft magnetic strip or a plurality of magnetic blocks are arranged between the magnetic glue layer and the eyelash stem, wherein:

the magnetic blocks are each a square magnet or a cylindrical magnet; and

the eyelash filaments are made of a biodegradable material or PBT (polybutylene terephthalate).

Further, the biodegradable material may be polylactic acid or starch-based resin.

Further, two closely adjacent magnetic blocks may be arranged at each of the two outermost ends of the first side of the eyelash stem.

Further, 6-20 magnetic blocks may be arranged between the magnetic glue layer and the eyelash stem.

Further, the size of the square magnet may be 1 mm×1 mm×(0.1 to 0.2) mm, and the size of the cylindrical magnet may be 1 mm in diameter of the bottom surface and 0.2 to 0.4 mm in height.

A method for preparing magnetic false eyelashes includes the following operations:

(1) Preparation of magnetic blocks:

subjecting the magnetic blocks to secondary deep polishing using an electric grinder to obtain the magnetic blocks after the secondary deep polishing, in which:

the magnetic blocks after the secondary deep polishing are each a square magnet with dimensions of 1 mm×1 mm×0.1˜0.2 mm; or

the magnetic blocks after the second deep polishing are each a cylindrical magnet, with dimensions of a diameter of the bottom surface being 1 mm, and a height being 0.2˜0.4 mm;

(2) Gluing the eyelash filaments evenly on the first side of the eyelash stem;

(3) Using a medical pressure-sensitive adhesive to inlay a soft magnetic strip or 6-20 magnetic blocks obtained in operation (1) on the first side of the eyelash stem;

(4) Preparation of magnetic glue:

Mixing the non-magnetic powder and the colloid evenly by a mass ratio (40˜65):(35˜60) to obtain the magnetic glue, where:

the colloid is a first colloid or a second colloid or a third colloid;

the first colloid includes 40-60 parts of solvent-based light-curing synthetic resin, 40-45 parts of mixed organic solvent, 0-1 part of carbon black or ink, and 0-5 parts of epoxy resin;

the second colloid includes 40 to 65 parts of polyacrylate polymer or polyvinyl ether, 0.5 to 2 parts of emulsifier, 40 to 55 parts of deionized water, and 1 to 2 parts of carbon black;

the third colloid includes 69 to 81 parts of vinyl silicone oil with a viscosity of 10,000, 14 to 26 parts of a filler, 3 to 7 parts of hydrogen-containing silicone oil, 0.2-0.5 parts of platinum catalyst, and 0.01-0.05 parts of inhibitor, in which:

the filler is white carbon black and/or organic montmorillonite;

the inhibitor includes at least one selected from the group consisting of 1-ethynyl-1-cyclohexanol, 2-methyl-3-butyn-ol, 3,5-dimethyl-1-hexyn-3-ol, and 3-Methyl-1-dodecyn-3-ol.

(5) Applying the magnetic glue obtained in operation (4) to the exterior of the first side of the eyelash stem by a high-pressure spray gun or by manual brushing to make it evenly distributed on the magnets and the eyelash stem, and letting it dry at least half an hour after completion to obtain the magnetic false eyelashes.

Further, the particle size of the non-magnetic magnetic powder in operation (4) lies in the range of 200 mesh to 800 mesh.

Further, the solvent-based light-curing synthetic resin may be one of unsaturated polyester, epoxy acrylate, urethane acrylate, and polyester acrylate.

Further, the mixed organic solvent may include turpentine, lemon oil, butanol, cyclohexanol, and terpineol in equal volume ratios.

Further, the emulsifier is fatty acid polyoxyethylene ester or polyethylene glycol.

Beneficial effects: The magnetic false eyelashes and the preparation method thereof disclosed in the present disclosure may have the following beneficial effects:

1. The present disclosure solves the problems of the existing magnetic false eyelashes, including oversized magnets, obvious bumpy feel, the magnets being easy to fall off, and rigid eyelash stem.

2. Using biodegradable materials to prepare eyelash filaments, so that the new product is more comfortable, safer, more durable, more economical, and greatly protects the environment, thereby reducing the pollution of fast-moving products to the ecological environments.

3. Convenient and easy to use, beautiful in appearance, and comfortable to wear.

### BRIEF DESCRIPTION OF DRAWINGS

FIG. 1 is a schematic diagram of Embodiment 1 of the magnetic false eyelashes according to the present disclosure.

FIG. 2 is a schematic diagram of Embodiment 5 of the magnetic false eyelashes according to the present disclosure.

FIG. 3 is a schematic diagram of Embodiment 8 of the magnetic false eyelashes according to the present disclosure.

FIG. 4 is a schematic diagram of Embodiment 9 of the magnetic false eyelashes according to the present disclosure.

In the drawings:
1—Eyelash
2—Magnet
3—Eyelash stem
4—Soft magnetic stripe

### DETAILED DESCRIPTION

Specific embodiments of the present disclosure will be described in detail below.

In this application, polylactic acid (PLA), also known as polylactide, is chemically synthesized using lactic acid, a product of microbial fermentation, as a monomer. It can automatically degrade after use and will not pollute the environment.

Starch-based resin, the potential advantage of using starch as raw material to develop biodegradable plastics is: starch has complete biodegradability in various environments; after starch molecules in plastics are degraded or ashed, carbon dioxide gas is formed, which is not harmful to the soil or the atmosphere; after adopting appropriate technology to make starch thermoplasticize, it can achieve the mechanical properties used to make plastic materials; starch is a renewable resource and it is inexhaustible.

### Embodiment 1

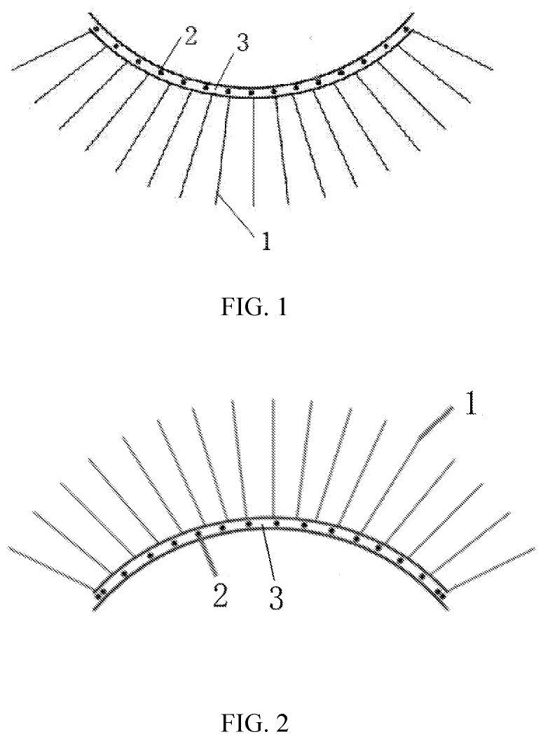

As illustrated in FIG. 1, magnetic false eyelashes include an eyelash stem 3, where a plurality of eyelash filaments are evenly distributed on a first side of the eyelash stem 3, a magnetic glue layer is arranged on the first side of the eyelash stem 3, and a number of 15 magnetic blocks 2 are arranged between the magnetic glue layer and the eyelash stem 3, wherein:

the magnetic blocks 2 are each a square magnet with dimensions of 1 mm×1 mm×0.1 mm;

the eyelash filaments 1 are made of a biodegradable material.

Further, the biodegradable material is polylactic acid.

A method for preparing magnetic false eyelashes includes the following operations:

(1) Preparation of magnetic blocks:

subjecting the magnetic blocks to secondary deep polishing using an electric grinder to obtain the magnetic blocks after the secondary deep polishing, in which:

the magnetic blocks after the secondary deep polishing are each a square magnet with dimensions of 1 mm×1 mm×0.1 mm;

(2) Gluing the eyelash filaments evenly on the first side of the eyelash stem;

(3) Using a medical pressure-sensitive adhesive to inlay 15 magnetic blocks obtained in operation (1) on the first side of the eyelash stem;

(4) Preparation of magnetic glue:

Mixing the non-magnetic magnetic powder and the colloid evenly by a mass ratio 40:35 to obtain the magnetic glue, where:

the colloid is a first colloid;

the first colloid includes 40 parts of solvent-based light-curing synthetic resin, and 40 parts of mixed organic solvent;

(5) Applying the magnetic glue obtained in operation (4) to the exterior of the first side of the eyelash stem by a high-pressure spray gun to make it evenly distributed on the magnets and the eyelash stem, and letting it dry at least half an hour after completion to obtain the magnetic false eyelashes.

Further, the particle size of the non-magnetic magnetic powder in operation (4) is 400 mesh.

Further, the solvent-based light-curing synthetic resin is an unsaturated polyester.

Further, the mixed organic solvent may include turpentine, lemon oil, butanol, cyclohexanol, and terpineol in equal volume ratios.

### Embodiment 2

Embodiment 2 is substantially the same as Embodiment 1, except that:

a number of 6 magnetic blocks 2 are arranged between the magnetic glue layer and the eyelash stem 3;

the magnetic blocks 2 are each a square magnet with dimensions of 1 mm×1 mm×0.2 mm;

the biodegradable material is starch-based resin;

the first colloid includes 60 parts of solvent-based light-curing synthetic resin, 45 parts of mixed organic solvent, 1 part of carbon black or ink, and 5 parts of epoxy resin;

the particle size of the non-magnetic magnetic powder in operation (4) is 800 mesh;

the solvent-based light-curing synthetic resin is polyurethane acrylate;

### Embodiment 3

Embodiment 2 is substantially the same as Embodiment 1, except that:

a number of 20 magnetic blocks 2 are arranged between the magnetic glue layer and the eyelash stem 3;

the magnetic blocks 2 are each a square magnet with dimensions of 1 mm×1 mm×0.15 mm;

the first colloid includes 50 parts of solvent-based light-curing synthetic resin, 42 parts of mixed organic solvent, 0.5 part of carbon black or ink, and 0.5 parts of epoxy resin;

Applying the magnetic glue obtained in operation (4) to the exterior of the first side of the eyelash stem by manual brushing to make it evenly distributed on the magnets and the eyelash stem, and letting it dry at least half an hour after completion to obtain the magnetic false eyelashes;

the particle size of the non-magnetic magnetic powder in operation (4) is 200 mesh.

the solvent-based light-curing synthetic resin is epoxy acrylate.

### Embodiment 4

Embodiment 2 is substantially the same as Embodiment 1, except that:

the magnet blocks 2 are each a cylindrical magnet, the dimensions of which are a diameter of 1 mm of the bottom surface and a height of 0.3 mm;

the solvent-based light-curing synthetic resin is polyester acrylate.

### Embodiment 5

As illustrated in FIG. 2, magnetic false eyelashes include an eyelash stem 3, where a plurality of eyelash filaments are evenly distributed on a first side of the eyelash stem 3, a magnetic glue layer is arranged on the first side of the eyelash stem 3, and a number of 13 magnetic blocks 2 are arranged between the magnetic glue layer and the eyelash stem 3, wherein:

the magnet blocks 2 are each a cylindrical magnet, the dimensions of which are a diameter of 1 mm of the bottom surface and a height of 0.2 mm;

the eyelash filament 1 is made of PBT;

two closely adjacent magnetic blocks 2 may be arranged at each of the two outermost ends of the first side of the eyelash stem 3.

Further, the biodegradable material may be polylactic acid or starch-based resin.

A method for preparing magnetic false eyelashes includes the following operations:

(1) Preparation of magnetic blocks:

subjecting the magnetic blocks to secondary deep polishing using an electric grinder to obtain the magnetic blocks after the secondary deep polishing, in which:

the magnetic blocks after the second deep polishing are each a cylindrical magnet, with dimensions of a diameter of the bottom surface being 1 mm, and a height being 0.2 mm;

(2) Gluing the eyelash filaments evenly on the first side of the eyelash stem;

(3) Using a medical pressure-sensitive adhesive to inlay 13 magnetic blocks obtained in operation (1) on the first side of the eyelash stem, gluing two closely adjacent magnetic blocks 2 onto each of the two outermost ends of the first side of the eyelash stem 3;

(4) Preparation of magnetic glue:

Mixing the non-magnetic magnetic powder and the colloid evenly by a mass ratio 65:60 to obtain the magnetic glue, where:

the colloid is a second colloid;

the second colloid includes 40 parts of polyacrylate polymer, 0.5 parts of emulsifier, 40 parts of deionized water, and 1 part of carbon black;

(5) Applying the magnetic glue obtained in operation (4) to the exterior of the first side of the eyelash stem by a high-pressure spray gun to make it evenly distributed on the magnets and the eyelash stem, and letting it dry at least half an hour after completion to obtain the magnetic false eyelashes.

Further, the particle size of the non-magnetic magnetic powder in operation (4) is 300 mesh.

Further, the emulsifier is fatty acid polyoxyethylene ester.

### Embodiment 6

Embodiment 2 is substantially the same as Embodiment 5, except that:

the second colloid includes 65 parts of polyacrylate polymer or polyvinyl ether, 2 parts of emulsifier, 55 parts of deionized water, and 2 parts of carbon black;

the emulsifier is polyethylene glycol.

### Embodiment 7

Embodiment 2 is substantially the same as Embodiment 5, except that:

the second colloid includes 50 parts of polyacrylate polymer or polyvinyl ether, 1 part of emulsifier, 47.5 parts of deionized water, and 1.5 parts of carbon black;

the emulsifier is polyethylene glycol.

### Embodiment 8

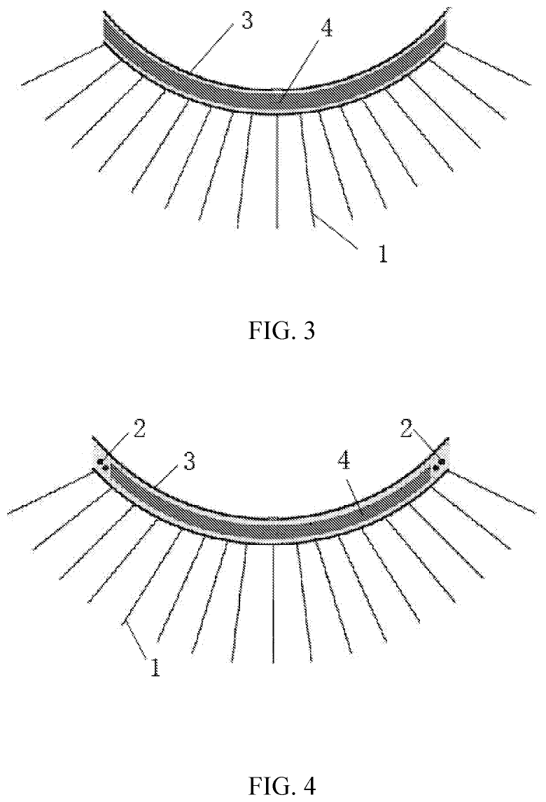

As illustrated in FIG. 3, magnetic false eyelashes include an eyelash stem 3, where a plurality of eyelash filaments are evenly distributed on a first side of the eyelash stem 3, a magnetic glue layer is arranged on the first side of the eyelash stem 3, and a soft magnetic stripe 4 is arranged between the magnetic glue layer and the eyelash stem 3, wherein:

the eyelash filaments 1 are made of a biodegradable material.

Further, the biodegradable material is polylactic acid.

A method for preparing magnetic false eyelashes includes the following operations:

(1) Gluing the eyelash filaments evenly on the first side of the eyelash stem;

(2) Using a medical pressure-sensitive adhesive to inlay the soft magnetic strip 4 in the first side of the eyelash stem;

(3) Preparation of magnetic glue:

Mixing the non-magnetic magnetic powder and the colloid evenly by a mass ratio 45:55 to obtain the magnetic glue, where:

the colloid is a third colloid;

the third colloid includes 75 parts of vinyl silicone oil with a viscosity of 10,000, 15 parts of a filler, 5 parts of hydrogen-containing silicone oil, 0.3 parts of platinum catalyst, and 0.03 parts of an inhibitor, in which:

the filler is white carbon black;

the inhibitor is 1-ethynyl-1-cyclohexanol.

(4) Applying the magnetic glue obtained in operation (3) to the exterior of the first side of the eyelash stem by manual brushing to make it evenly distributed on the magnets and the eyelash stem, and letting it dry at least half an hour after completion to obtain the magnetic false eyelashes.

Further, the particle size of the non-magnetic magnetic powder in operation (4) is 800 mesh.

### Embodiment 9

As illustrated in FIG. 4, magnetic false eyelashes include an eyelash stem 3, where a plurality of eyelash filaments are evenly distributed on a first side of the eyelash stem 3, a magnetic glue layer is arranged on the first side of the eyelash stem 3, and a soft magnetic stripe 4 is arranged between the magnetic glue layer and the eyelash stem 3, and two closely adjacent magnetic blocks 2 are arranged at each of the two outermost ends of the first side of the eyelash stem 3, wherein:

the magnetic blocks 2 are each a square magnet with dimensions of 1 mm×1 mm×0.15 mm;

the eyelash filaments 1 are made of a biodegradable material.

Further, the biodegradable material is polylactic acid.

A method for preparing magnetic false eyelashes includes the following operations:

(1) Preparation of magnetic blocks:

subjecting the magnetic blocks to secondary deep polishing using an electric grinder to obtain the magnetic blocks after the secondary deep polishing, in which:

the magnetic blocks after the secondary deep polishing are each a square magnet with dimensions of 1 mm×1 mm×0.15 mm;

(2) Gluing the eyelash filaments evenly on the first side of the eyelash stem;

(3) Using a medical pressure-sensitive adhesive to inlay the soft magnetic stripe 4 on the first side of the eyelash stem, and further gluing the two closely adjacent magnetic blocks 2 onto each of the two outermost ends of the first side of the eyelash stem 3;

(4) Preparation of a magnetic glue:

Mixing the non-magnetic magnetic powder and the colloid evenly by a mass ratio 40:35 to obtain the magnetic glue, where:

the colloid is a third colloid;

the third colloid includes 69 parts of vinyl silicone oil with a viscosity of 10,000, 14 parts of a filler, 3 parts of hydrogen-containing silicone oil, 0.2 parts of platinum catalyst, and 0.01 parts of an inhibitor, in which:

the filler is white carbon black;

the inhibitor is 1-ethynyl-1-cyclohexanol.

(5) Applying the magnetic glue obtained in operation (4) to the exterior of the first side of the eyelash stem by a high-pressure spray gun to make it evenly distributed on the magnets and the eyelash stem, and letting it dry at least half an hour after completion to obtain the magnetic false eyelashes.

the particle size of the non-magnetic magnetic powder in operation (4) is 200 mesh.

### Embodiment 10

Embodiment 2 is substantially the same as Embodiment 9, except that:

the magnetic blocks 2 are each a square magnet with dimensions of 1 mm×1 mm×0.1 mm;

the biodegradable material is starch-based resin;

(4) Preparation of magnetic glue:

Mixing the non-magnetic magnetic powder and the colloid evenly by a mass ratio 65:60 to obtain the magnetic glue, where:

the colloid is a third colloid;

the third colloid includes 81 parts of vinyl silicone oil with a viscosity of 10,000, 26 parts of a filler, 7 parts of hydrogen-containing silicone oil, 0.5 parts of platinum catalyst, and 0.05 parts of an inhibitor, in which:

the filler is organic montmorillonite;

the inhibitor is 2-methyl-3-butyn-ol.

(5) Applying the magnetic glue obtained in operation (4) to the exterior of the first side of the eyelash stem by a high-pressure spray gun to make it evenly distributed on the magnets and the eyelash stem, and letting it dry at least half an hour after completion to obtain the magnetic false eyelashes.

the particle size of the non-magnetic magnetic powder in operation (4) is 800 mesh.

### Embodiment 11

Embodiment 2 is substantially the same as Embodiment 9, except that:

the magnetic blocks 2 are each a square magnet with dimensions of 1 mm×1 mm×0.2 mm;

(4) Preparation of magnetic glue:

Mixing the non-magnetic magnetic powder and the colloid evenly by a mass ratio 50:50 to obtain the magnetic glue, where:

the colloid is a third colloid;

the third colloid includes 75 parts of vinyl silicone oil with a viscosity of 10,000, 20 parts of a filler, 5 parts of hydrogen-containing silicone oil, 0.3 parts of platinum catalyst, and 0.03 parts of an inhibitor, in which:

the filler is white carbon black and organic montmorillonite in equal volumes; and

the inhibitor is 3,5-dimethyl-1-hexyn-3-ol.

(5) Applying the magnetic glue obtained in operation (4) to the exterior of the first side of the eyelash stem by a high-pressure spray gun to make it evenly distributed on the magnets and the eyelash stem, and letting it dry at least half an hour after completion to obtain the magnetic false eyelashes.

Further, the particle size of the non-magnetic magnetic powder in operation (4) is 400 mesh.

### Embodiment 12

Embodiment 2 is substantially the same as Embodiment 9, except that:

the magnetic blocks after the second deep polishing are each a cylindrical magnet, with dimensions of a diameter of the bottom surface being 1 mm, and a height being 0.4 mm;

the inhibitor is 3-methyl-1-dodecyn-3-ol.

The embodiments of the present disclosure have been described in detail above. However, the present disclosure will not be limited to the above-mentioned embodiments, and various changes can be made without departing from the spirit and scope of the present disclosure within the scope of knowledge possessed by those having ordinary skill in the art.

What is claimed is:

1. Magnetic false eyelashes, comprising an eyelash stem, wherein a plurality of eyelash filaments are evenly distributed on a first side of the eyelash stem, a magnetic glue layer is disposed on the first side of the eyelash stem, and a soft magnetic stripe or a plurality of magnetic blocks are disposed between the magnetic glue layer and the eyelash stem, wherein:
the plurality of magnetic blocks are each a square magnet or a cylindrical magnet; and
the plurality of eyelash filaments are made of a biodegradable material or PBT.

2. The magnetic false eyelashes as recited in claim 1, wherein the biodegradable material comprises polylactic acid or starch-based resin.

3. The magnetic false eyelashes as recited in claim 1, wherein two closely adjacent magnetic blocks are arranged at each of two outermost ends of the first side of the eyelash stem.

4. The magnetic false eyelashes as recited in claim 1, wherein a number of 6 to 20 magnetic blocks are disposed between the magnetic glue layer and the eyelash stem.

5. The magnetic false eyelashes as recited in claim 1, wherein the square magnet has dimensions of 1 mm×1 mm×(0.1 to 0.2) mm, and the cylindrical magnet has dimensions of 1 mm in diameter of a bottom surface and 0.2 to 0.4 mm in height.

6. A method of preparing magnetic false eyelashes, comprising the following operations:
(1) Preparation of magnetic blocks: subjecting magnetic blocks to secondary deep polishing using an electric grinder to obtain magnetic blocks that have been polished after the secondary deep polishing, wherein:
the magnetic blocks after the secondary deep polishing are each a square magnet with dimensions of 1 mm×1 mm×(0.1˜0.2) mm; or
the magnetic blocks after the second deep polishing are each a cylindrical magnet, with dimensions of 1 mm in diameter of a bottom surface, and 0.2˜0.4 mm in height;
(2) Gluing eyelash filaments evenly on a first side of an eyelash stem;
(3) Using a medical pressure-sensitive adhesive to inlay a soft magnetic strip or a number of 6 to 20 magnetic blocks obtained in operation (1) in the first side of the eyelash stem;
(4) Preparation of a magnetic glue: mixing a non-magnetic powder and a colloid evenly by a mass ratio of (40˜65):(35˜60) to obtain the magnetic glue, wherein the colloid is a first colloid or a second colloid or a third colloid;
the first colloid comprises 40 to 60 parts of a solvent-based light-curing synthetic resin, 40 to 45 parts of a mixed organic solvent, 0 to 1 part of carbon black or ink, and 0 to 5 parts of epoxy resin;
the second colloid comprises 40 to 65 parts of polyacrylate polymer or polyvinyl ether, 0.5 to 2 parts of emulsifier, 40 to 55 parts of deionized water, and 1 to 2 parts of carbon black;
the third colloid comprises 69 to 81 parts of vinyl silicone oil with a viscosity of 10,000, 14 to 26 parts of a filler, 3 to 7 parts of hydrogen-containing silicone oil, 0.2 to 0.5 parts of platinum catalyst, and 0.01 to 0.05 parts of an inhibitor, wherein the filler is white carbon black and/or organic montmorillonite, the inhibitor comprises at least one selected from the group consisting of 1-ethynyl-1-cyclohexanol, 2-methyl-3-butyn-ol, 3,5-dimethyl-1-hexyn-3-ol, and 3-Methyl-1-dodecyn-3-ol;
(5) Applying the magnetic glue obtained in operation (4) to an exterior of the first side of the eyelash stem by a high-pressure spray gun or by manual brushing to make it evenly distributed on the magnets and the eyelash stem, and letting it dry for at least half an hour after completion to obtain the magnetic false eyelashes.

7. The method as recited in claim 6, wherein the non-magnetic magnetic powder in operation (4) has a particle size of 200 mesh to 800 mesh.

8. The method as recited in claim 6, wherein the solvent-based light-curing synthetic resin comprises one of unsaturated polyester, epoxy acrylate, urethane acrylate, or polyester acrylate.

9. The method as recited in claim 6, wherein the mixed organic solvent comprises turpentine, lemon oil, butanol, cyclohexanol, and terpineol in equal volumes.

10. The method as recited in claim 6, wherein the emulsifier is fatty acid polyoxyethylene ester or polyethylene glycol.
